(19) United States
(12) Patent Application Publication
(10) Pub. No.: US 2023/0236369 A1
(43) Pub. Date: Jul. 27, 2023

(54) SYSTEM AND METHOD FOR VERTICALLY ALIGNING OPTICAL FIBER TO PHOTONIC WAFERS

(71) Applicant: Lumentum Operations LLC, San Jose, CA (US)

(72) Inventors: Zeyu PAN, Edison, NJ (US); Guilhem DEVALICOURT, Jersey City, NJ (US)

(21) Appl. No.: 18/001,909

(22) PCT Filed: Jun. 3, 2021
(86) PCT No.: PCT/US2021/035590

§ 371 Date: Dec. 15, 2022

Related U.S. Application Data
(60) Provisional application No. 63/041,210, filed on Jun. 19, 2020.

(51) Int. Cl. G02B 6/42; G02B 6/30; G02B 6/125

(52) U.S. Cl. CPC G02B 6/4222; G02B 6/30; G02B 6/125

(57) ABSTRACT

A method and system of determining a z-distance between an optical fiber and a substrate are presented. The method can include, for instance: obtaining an image that includes an end of the optical fiber and a reflection of the end of the optical fiber from a surface of the substrate, and processing the image to determine a z-distance along a z-axis between the end of the optical fiber and the substrate.

### RELATED APPLICATIONS

This application claims priority under 35 U.S.C. § 119(e) to U.S. Provisional Application Ser. No. 63/041,210, titled SYSTEM AND METHOD FOR VERTICALLY ALIGNING OPTICAL FIBER TO PHOTONIC WAFERS, filed on Jun. 19, 2020, which is herein incorporated by reference in its entirety.

### BACKGROUND

### Technical Field

The technical field relates generally to systems and methods for vertically aligning an optical fiber to a substrate, and more specifically to determining a z-distance between an optical fiber and a substrate such as a photonic wafer.

### Background Discussion

A photonic integrated circuit (PIC) or integrated optical circuit is a device that integrates multiple (at least two) photonic functions and as such is analogous to an electronic integrated circuit. The major difference between the two is that a photonic integrated circuit provides functionality for information signals imposed on optical wavelengths typically in the visible or near-infrared spectrums. PICs are used for various applications in telecommunications, instrumentation, and signal-processing fields. A PIC typically uses optical waveguides to implement and/or interconnect various on-chip components, such as waveguides, optical switches, couplers, routers, splitters, multiplexers/demultiplexers, modulators, amplifiers, wavelength converters, optical-to-electrical (O/E) and electrical-to-optical (E/O) signal converters (e.g., photodiodes, lasers), etc.

A waveguide in a PIC is usually an on-chip solid light conductor that guides light. For proper operation, a PIC typically needs to efficiently couple light between an external optical fiber and one or more on-chip waveguides. There are two different approaches for coupling light from the optical fibers to PICs.

In the first method, the optical fiber is coupled to the edge of a PIC. This requires that the die be diced from the wafer. Consequently, the PICs cannot be tested on a wafer and must be packaged before determining whether a PIC functions properly. This increases production costs for the PICs and requires stringent alignment tolerances between the optical fiber and the end of the waveguide.

In the second method, light from the optical fibers is coupled in/out of the PIC using diffractive grating couplers. In this case, the optical fibers are butt-coupled to the flat surface of the PIC and light exits/enters the PIC from/to the flat surface. An example of this coupling configuration is shown in FIGS. 1A and 1B. FIG. 1A is a cross-sectional front view of a first optical fiber 120a vertically aligned to a first grating coupler 112a (an optical coupler) of a PIC that forms a substrate 105 for optically coupling the fiber. As indicated by the arrows, light enters the PIC through a first grating coupler 112a from the optical fiber 120a and propagates through a waveguide 114 of the PIC before it exits through a second grating coupler 112b and a second optical fiber 120b. The fiber grating couplers are thus used as an “optical bond pad” for launching and receiving optical signals. FIG. 1B is a perspective view of the configuration shown in FIG. 1A. The vertical alignment configuration allows for PICs to be tested prior to dicing using probers that incorporate electrical and fiber-optic probe heads.

Testing via optical probing presents a different set of complications than electrical probing. For one thing, the positioning tolerances for photonic probing are typically two orders of magnitude tighter than for electrical probing. In contrast to the alignment requirements for purely electrical testing, the optical fibers need to be aligned in six different spatial (x, y, z) and angular (pitch, yaw, rotation) directions. Lateral alignments can be very accurate using piezo-controlled stages and active alignment, where light is generated or detected on the PIC chip and the optical coupling is optimized by maximizing the coupled optical power to the optical fiber. However, non-contact measurement and precise height control are also needed. Variations in wafer chuck topography can also further complicate vertical alignment positioning. Conventional alignment systems rely on the use of multiple sensors and/or specialized alignment systems. For instance, such systems often include extra sensors that require sophisticated fixtures and calibration.

### SUMMARY

Aspects and embodiments are directed to a method and system for determining a z-distance between an optical fiber and a substrate.

In accordance with one or more aspects, a method of determining a z-distance between an optical fiber and a substrate is provided. The method includes obtaining an image that includes an end of the optical fiber and a reflection of the end of the optical fiber from a surface of the substrate, and processing the image to determine a z-distance along a z-axis between the end of the optical fiber and the substrate.

In one example, obtaining the image includes obtaining a grayscale image that includes a plurality of pixels, and processing the image comprises thresholding the grayscale image to generate a binary image.

In a further example, processing the image further includes: comparing a first template image corresponding to a representation of the end of the optical fiber to the binary image to detect a first subset of the plurality of pixels in the binary image that match the first template image, the first subset of the plurality of pixels corresponding to a representation of the end of the optical fiber, comparing a second template image corresponding to a representation of the reflection of the end of the optical fiber from the surface of the substrate to the binary image to detect a second subset of the plurality of pixels in the binary image that match the second template image, the second subset of the plurality of pixels corresponding to a representation of the reflection of the end of the optical fiber from the surface of the substrate, and determining a number of pixels of the plurality of pixels that exist between the first subset and the second subset, the number of pixels corresponding to the z-distance.

In another example, the method further includes obtaining and storing each of the first and second template images.

In one example, the method further includes performing a calibration process, the calibration process comprising moving the optical fiber to selected positions along the z-axis.

In another example, the method further includes determining the z-distance from an image obtained at each selected position, and applying a fitting algorithm to a comparison between the determined z-distances and known z-distances.

In another example, the method further includes: for each image obtained at each selected position, determining an image z-location for each of the end of the optical fiber and its respective reflection, comparing the determined image z-locations to known z-distances, and calculating an image compensation calibration factor based on the comparison.

In one example, the method includes determining an x-position for each of the end of the optical fiber and its reflection.

In one example, the method includes determining the x-position comprises moving the optical fiber to selected positions along the z-axis and determining an x-position for each of the end of the optical fiber and its reflection for at least two selected positions, and the method further comprises performing a comparison between the determined x-position at the two selected positions for each of the end of the optical fiber and its reflection.

In another example, the method further includes moving the optical fiber to a z-distance at which the optical fiber is vertically aligned to the substrate.

In another example, the optical fiber is vertically aligned such that less than 0.5 decibels (dB) optical insertion loss is introduced between the optical fiber and the substrate.

In a further example, the optical fiber is vertically aligned such that less than 0.2 dB optical insertion loss is introduced. In another example, the optical fiber is vertically aligned with an accuracy within one micron.

In accordance with one or more aspects, a system for determining a z-distance between an optical fiber and a substrate is provided. The system includes: a camera configured to obtain an image of an end of the optical fiber and a reflection of the end of the optical fiber from a surface of the substrate, and an image processor configured to receive and process the image and determine a z-distance along a z-axis between the end of the optical fiber and the substrate.

In one example, the image is a grayscale image that includes a plurality of pixels and the image processor is configured to process the image by thresholding the grayscale image to generate a binary image.

In another example, the image processor is further configured to: compare a first template image corresponding to a representation of the end of the optical fiber to the binary image to detect a first subset of the plurality of pixels in the binary image that match the first template image, the first subset of the plurality of pixels corresponding to a representation of the end of the optical fiber, compare a second template image corresponding to a representation of the reflection of the end of the optical fiber from the surface of the substrate to the binary image to detect a second subset of the plurality of pixels in the binary image that match the second template image, the second subset of the plurality of pixels corresponding to a representation of the reflection of the end of the optical fiber from the surface of the substrate, and determine a number of pixels of the plurality of pixels that exist between the first subset and the second subset, the number of pixels corresponding to the z-distance.

In another example, the system further includes a drive mechanism configured to move the optical fiber along the z-axis to selected positions.

In one example, the image processor is configured to determine the z-distance from an image obtained at each selected position, and the system further comprises a computing device configured to apply a fitting algorithm to a comparison between the determined z-distances and known z-distances.

In another example, the image processor is configured to determine an image z-location for each of the end of the optical fiber and its respective reflection for each image obtained at each selected position, and the system further comprises a computing device configured to compare the determined image z-locations to known z-distances, and calculate an image compensation calibration factor based on the comparison.

In another example, the image processor is further configured to determine an x-position for each of the end of the optical fiber and its reflection. In a further example, the image processor is further configured to calculate a matching factor for each of the determined x-positions for the end of the optical fiber and its reflection. In one example, the image processor is configured to provide one or more outputs when at least one of the calculated matching factors exceeds a threshold value.

In one example, the substrate includes a photonic integrated circuit (PIC), and the optical fiber is vertically aligned to a grating coupler of the PIC.

Still other aspects, embodiments, and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Embodiments disclosed herein may be combined with other embodiments, and references to “an embodiment,” “an example,” “some embodiments,” “some examples,” “an alternate embodiment,” “various embodiments,” “one embodiment,” “at least one embodiment,” “this and other embodiments,” “certain embodiments,” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A is a schematic diagram of a cross-sectional front view of a pair of optical fibers vertically aligned to a PIC;

FIG. 1B is a schematic diagram of a perspective view of the optical fibers and PIC of FIG. 1A;

FIG. 2 is a top view of a wafer containing multiple PICs;

FIG. 3A is a side view block diagram of a system for aligning an optical fiber to a substrate in accordance with aspects of the invention;

FIG. 3B is a side view schematic of a system for aligning an optical fiber to a substrate in accordance with aspects of the invention;

FIG. 3C is a front view of the system of FIG. 3B;

FIG. 4 is a schematic diagram of an optical fiber and a reflection of the optical fiber on a substrate in accordance with aspects of the invention;

FIG. 5A is one example of an image taken from a camera that shows a pair of optical fibers and their respective reflections on the surface of the substrate in accordance with aspects of the invention;

FIG. 5B is another example of an image taken from a camera (left side) of a pair of optical fibers and their respective reflections as well as a corresponding 2D image coordinate system (right side) used in accordance with aspects of the invention;

FIG. 6A is one example of an image taken from a camera that shows a pair of optical fibers and their respective reflections on the surface of the substrate;

FIG. 6B is a sub-section of the image from FIG. 6A;

FIG. 6C is an image showing a magnification of a portion of FIG. 6B that shows the end of the optical fiber;

FIG. 6D is an image showing a magnification of a portion of FIG. 6B that shows the reflection of the optical fiber on the surface of the substrate;

FIG. 7A is a processed image of FIG. 6A;

FIG. 7B shows a magnified portion of FIG. 7A that represents the end of the optical fiber;

FIG. 7C shows a magnified portion of FIG. 7A that represents the reflection of the optical fiber on the surface of the substrate;

FIG. 8 is a magnification of the dashed-line box of FIG. 7A;

FIG. 9 is a graph showing one example of the alignment accuracy of the optical fiber to a substrate in accordance with aspects of the invention;

FIGS. 10A and 10B are graphs showing the application of a fitting algorithm in accordance with aspects of the invention;

FIGS. 11A and 11B are a pair of graphs comparing alignment error in a fiber height adjustment technique in accordance with aspects of the invention.

FIGS. 12A-12D are a first set of graphs indicating the accuracy of the x-position of the optical fiber in the x-direction in accordance with aspects of the invention; and

FIGS. 13A-13D are a second set of graphs indicating the accuracy of the x-position of the optical fiber in the x-direction in accordance with aspects of the invention.

### DETAILED DESCRIPTION

Aspects and embodiments are directed to methods and systems for determining a z-distance between an optical fiber and a substrate. This z-distance (which can also be referred to herein as “fiber height”) is used for purposes of vertically aligning the optical fiber to the substrate and includes one of the three spatial dimensions ((-x, -y, -z,) or (longitudinal, lateral, and vertical)) used in aligning these fibers. An optimized z-distance therefore exists where the optical fiber is vertically aligned to the substrate within a desired tolerance. According to various aspects, the substrate is a PIC chip as described above. Silicon photonics devices, such as optical transceivers, need to be tested prior to being diced and sent to customers and at least a portion of this testing requires that the fiber be optically coupled to the PIC chip. Vertical alignment is therefore necessary to perform this testing.

As also mentioned previously, conventional alignment systems rely on complex hardware. In contrast, the disclosed methods and systems offer a simpler solution possessing the same level of accuracy by using cameras that may already be present in the system. For instance, a camera installed on a probe device can be used in combination with an image processor for purposes of aligning the optical fiber to the substrate. According to additional aspects of the invention, the methods and systems disclosed herein can also be used to monitor the alignment of the optical fiber in other spatial directions such as the -x and -y directions.

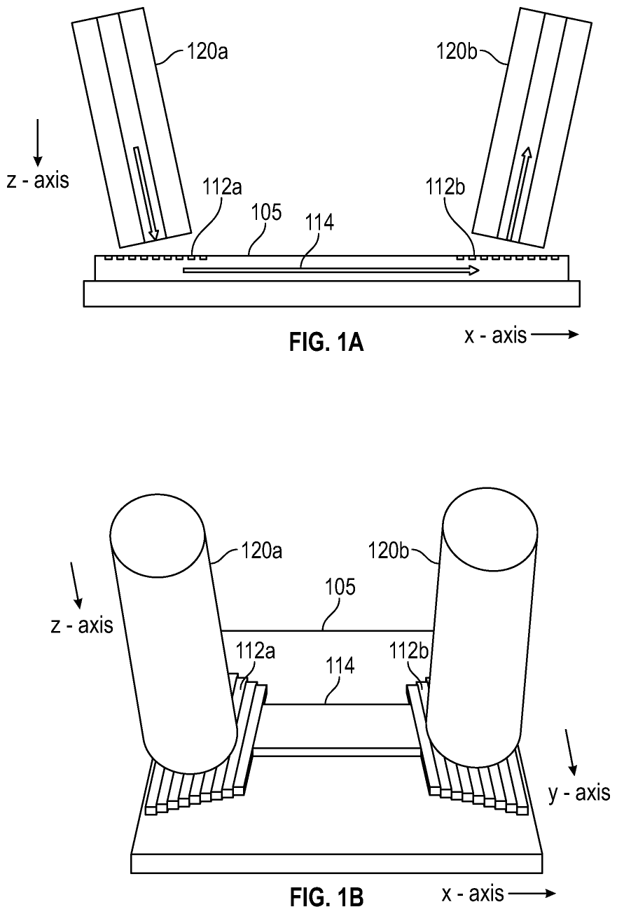

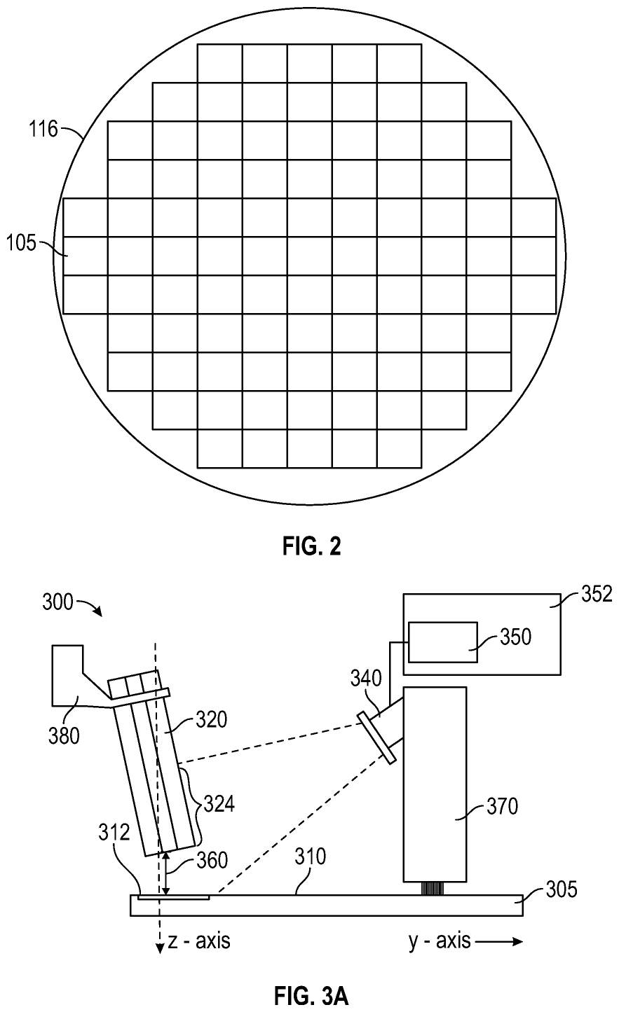

FIG. 2 is top view of a wafer 116 that contains separable PIC chips 105 arranged linearly across the wafer. Each wafer 116 is used to manufacture these PIC chips 105 and multiple PIC chips are formed during the manufacturing process on a single wafer. On-chip testing (i.e., before dicing or cleaving) is performed for each of the PIC chips 105, and to perform this testing, the optical fibers (e.g., 120a, 120b FIGS. 1A and 1B) need to be coupled to the PIC chip. This is a difficult task in part because the size of the optical field inside the PIC grating coupler is on the order of a few microns, which means that the fiber connection needs to be positioned with sub-micron precision in three dimensions to achieve an optimal coupling.

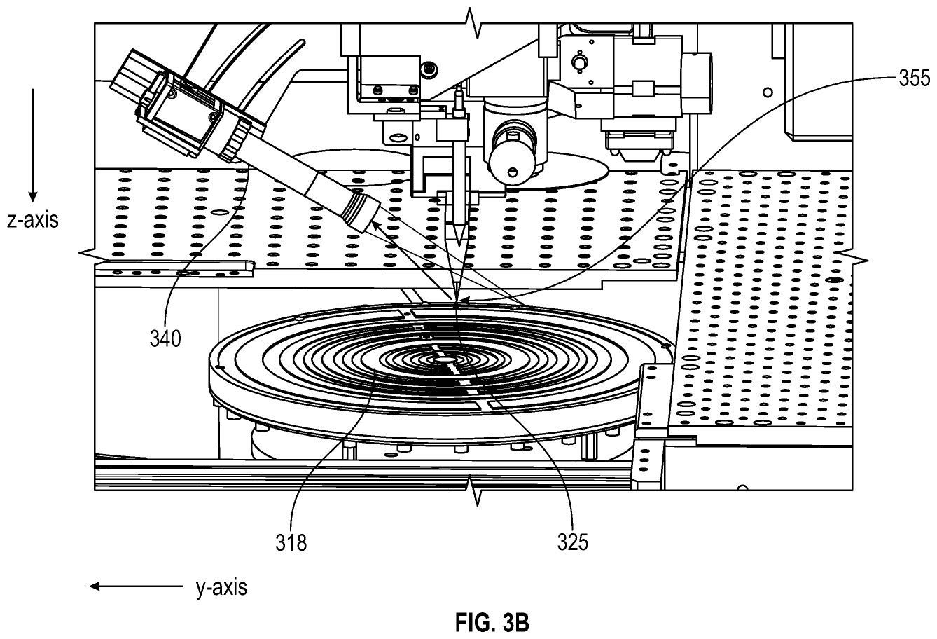

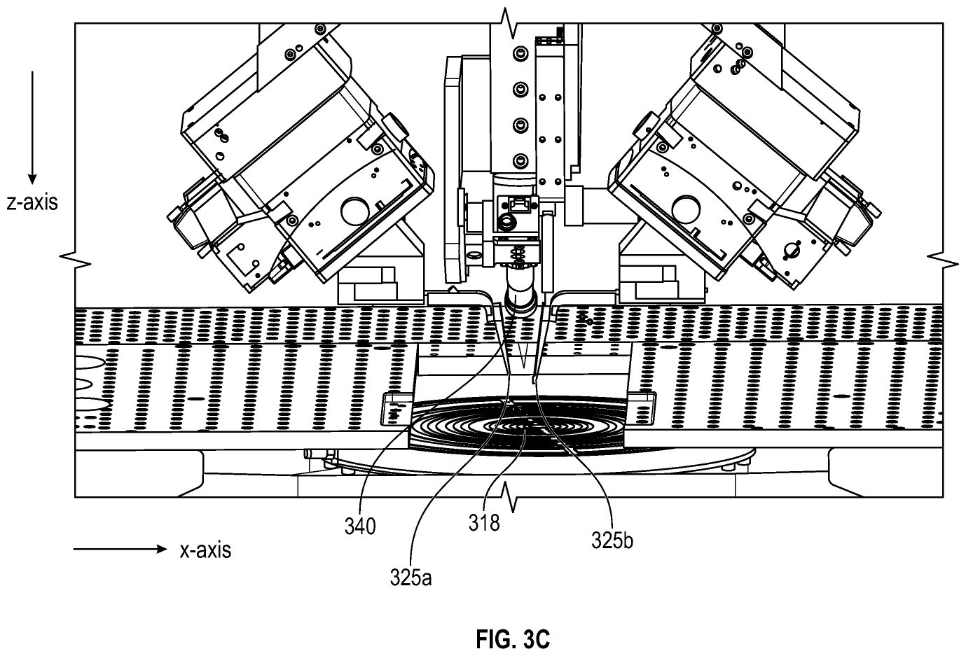

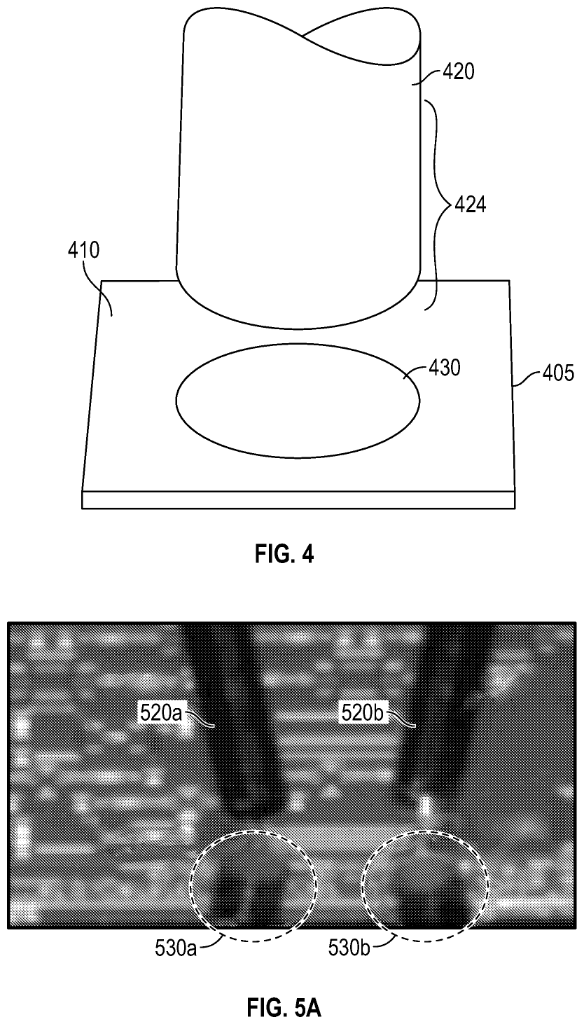

FIG. 3A is a side view block diagram showing one example of a system, generally shown at 300, that can be used for determining a z-distance (indicated as 360) between an optical fiber 320 and a substrate 305. System 300 includes a camera 340 that is used to obtain an image of an end of the optical fiber 324 and a reflection 430 (see FIG. 4) of the end of the optical fiber 324 from a surface 310 of the substrate 305. FIGS. 3B and 3C are schematic side and front views, respectively of a system similar to that of FIG. 3A. Wafer shuttle 318 of FIG. 3B holds the substrate 305 of FIG. 3A, and FIG. 3C shows two fiber holders 325a and 325b for holding respective optical fibers.

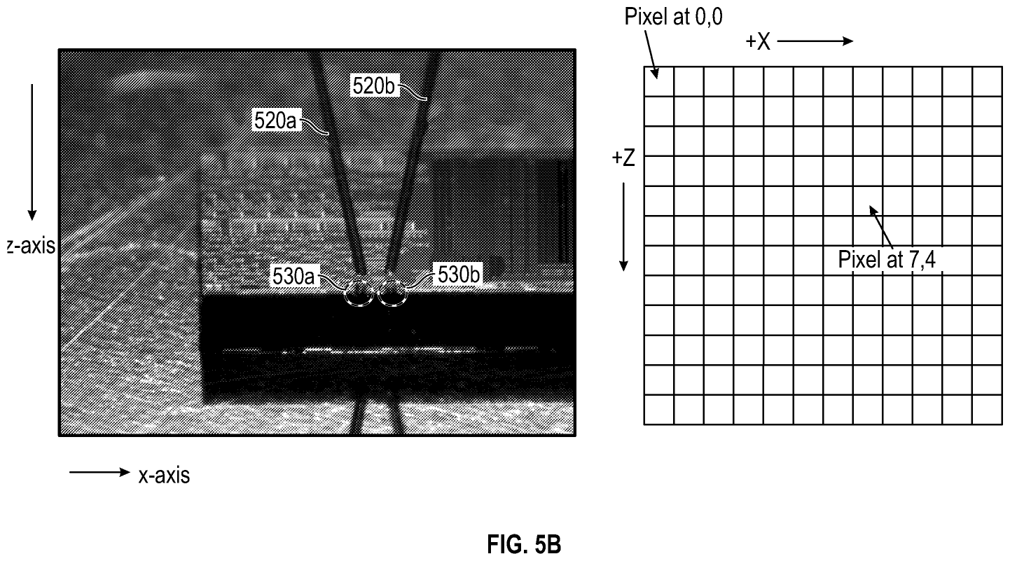

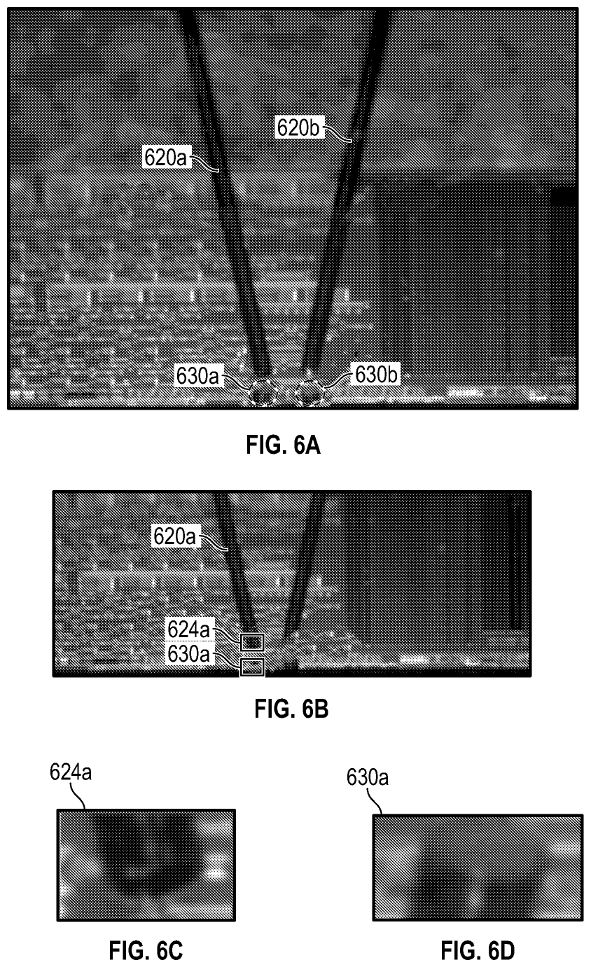

FIG. 4 is a block diagram showing an optical fiber 420 and its end portion 424 that can be imaged by a camera, as well as its reflection 430 on the surface 410 of a substrate 405 that is also imaged by the camera. It is this image that can be used to calculate the z-distance (i.e., height or vertical distance) between the optical fiber 420 and the substrate 405 since the reflection is in the same horizontal plane as the surface 410 of the substrate 405. FIG. 5A is one example of an image obtained from such a camera and depicts a pair of optical fibers 520a and 520b and their respective reflections 530a and 530b on the substrate surface. As shown in FIG. 5A, the reflections 530a and 530b can be obtained even if they cross over several structures (e.g., grating coupler, waveguide) on the surface of the substrate. FIG. 6A is another example of an image obtained from a camera that shows a pair of optical fibers 620a and 620b and their respective reflections 630a and 630b on the surface of the substrate. FIG. 6B is a portion of FIG. 6A with two boxes outlining the image of the end of the fiber 624a of fiber 620a and its reflection 630a. FIG. 6C is an enlarged image of the first box showing the end of the fiber 624a and FIG. 6D is an enlarged image of the second box showing the reflection 630a of the fiber 620a on the surface of the substrate.

Returning now to FIG. 3A, camera 340 is positioned such that its field of view (FOV) (see dashed lines) captures both the end of the optical fiber 324 and its reflection on the surface 310 of the substrate 305. This captured image of the end of the optical fiber and the reflection are further processed by an image processor 350, which in some instances may be part of a computing device 352. For instance, a computing device may be configured with image processing software (and otherwise referenced herein as an “image processor”). This process is described in further detail below. The computing device 352 also includes a processor and storage medium, as well as input/output components, as will be readily appreciated by those of skill in the art. In some instances, one or both of the image processor 350 and computing device 352 can function as a controller, as will be appreciated by those skilled in the art.

In accordance with one embodiment, the camera 340 is installed on the side of a wafer prober 370 that is used during testing of the PICs. According to some embodiments, the camera 340 is a digital camera. One non-limiting example of a camera suitable for the embodiments described herein is an industrial camera, such as model acA2500-14gm available from Basler AG. According to one configuration, an optical lens system (not shown) may be placed in front of the camera 340, i.e., between the camera 340 and the fiber tip. In one example, the distance between the optical lens system and the fiber tip is about 100 mm. System 300 also includes at least one light source 355 configured to provide light and assist the camera 340 in imaging the fiber and its reflection.

System 300 also includes an image processor 350. It is to be appreciated that there are several ways to implement the image processor, including the use of Open Source Computer Vision (OpenCV, www.opencv.org), which is an open source computer vision library. The image processor 350 is configured to receive and process images from the camera 340. The image received by the image processor 350 from the camera 340 includes image data that is composed of a plurality of pixels. The left side of FIG. 5B shows a larger perspective image of the image shown in FIG. 5A as explained above and is similar to that shown in FIG. 6A. As will be appreciated, this digital image can be thought of as a two-dimensional (2D) array of pixels. The right side of FIG. 5B shows a corresponding 2D image coordinate system that is used in reference to the images discussed within this disclosure. This coordinate system is used by the image processor 350 and portrays the image as an array of pixels that are addressed by their horizontal (x) and vertical (z) coordinates, with the origin 0,0 being positioned at the top left corner. Positive x coordinates increase to the right, and positive z coordinates increase downward, as indicated by the example pixel 7,4 in FIG. 5B. Such an image coordinate system will be recognized by those of skill in the art and is used herein in reference to the images obtained by the camera 340. As such, the fiber height (z-distance) has the same direction as the z-direction in the image coordinate system, and image z-locations for the reflections will have larger values than that of their respective fibers (because they are lower in the image).

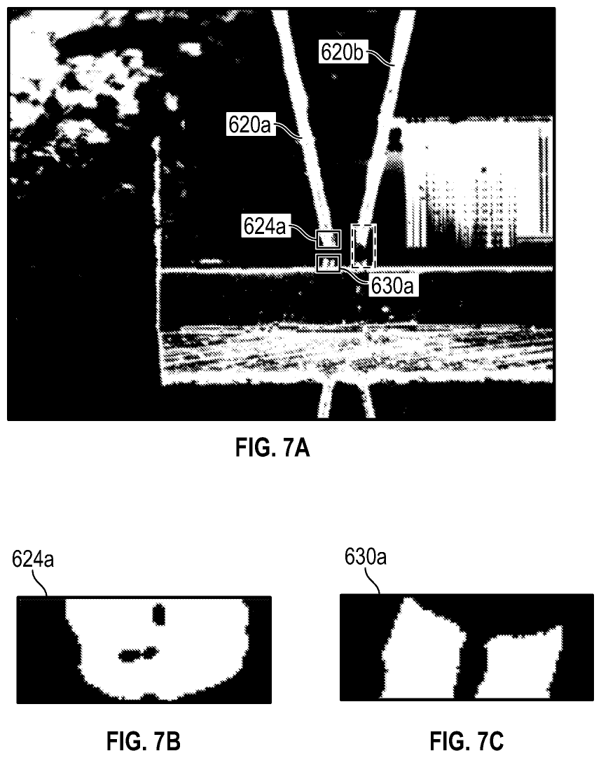

In accordance with at least one embodiment, the image obtained by the camera 340 is read or received as a grayscale image or otherwise converted to grayscale by the image processor 350. The image processor 350 then performs a contrast enhancement process (otherwise referred to herein as binarization) on the plurality of pixels included in the (grayscale) image to generate a binary image, i.e., transform the image into a binary scale. As will be appreciated by those of skill in the art, this can be accomplished by thresholding the image. An example of a binary image generated from the digital image of FIG. 6A is shown in FIG. 7A, with the corresponding binary images of the end of the fiber 624a and reflection 630a shown in FIGS. 7B and 7C, respectively. Thresholding includes comparing each pixel of the digital image with a binarization threshold, which can be chosen automatically by the image processor or by a user. If a pixel has a value above the binarization threshold, a first value (e.g., a maximum value) is assigned to the corresponding pixel in the binary image, otherwise a second value (e.g., a minimum value) is assigned to the corresponding pixel in the binary image. Suitable binarization processing algorithms can be obtained via the image thresholding functions available from OpenCV.

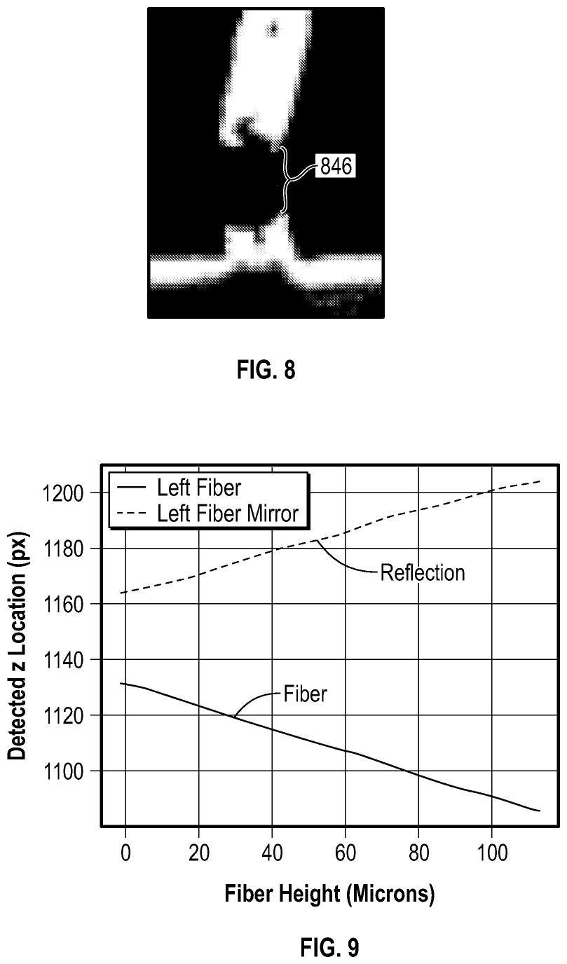

After contrast enhancement is performed, a pattern finding or pattern recognition algorithm, such as template matching (otherwise referred to herein as a template matching algorithm), may be used by the image processor on the binary image. An example suitable for use with the present invention is the matchTemplate function available from OpenCV. This process includes having the image processor 350 be configured to identify a first subset of pixels that correspond to a representation of the end of the optical fiber and to identify a second subset of pixels that correspond to a representation in the image of the reflection of the end of the optical fiber from the surface of the substrate. According to some embodiments, this process first includes creating a first template image corresponding to the end of the optical fiber and a second template image corresponding to the reflection of the fiber on the substrate surface. FIG. 7B is one example of the first template image corresponding to the end of the optical fiber and FIG. 7C is one example of the second template image corresponding to the reflection of the fiber from the substrate surface. These template images can be stored in an image library via a storage medium of the computing device 352, and are used by the image processor 350 for other obtained images from the camera to identify the fiber tip and the reflection and their respective locations within the obtained image. For example, the image template of FIG. 7B corresponding to the end of the optical fiber shown in FIG. 7B and the image template of FIG. 7C corresponding to the reflection of the fiber can be applied to the portion of the image in FIG. 7A corresponding to the second fiber 620b. The image processor 350 compares the template images to the image of interest and locates template features corresponding to the end of the optical fiber and the reflection of the fiber in the image of interest based on where the templates best “match” these template features within the image of interest. Once this is done, the image processor 350 and/or a processor of the computing device 352 is also configured to calculate the number of pixels between the fiber and the reflection, which is indicated in the area marked as 846 in FIG. 8. These “in-between” pixels 846 correspond to z-distance 360 in FIG. 3A. For instance, the image processor 350 may first find the pattern similar to FIG. 7B, which is the image of the fiber tip, and then find the pattern similar to FIG. 7C, which is the image of reflection. The distance is calculated by subtracting the respective z-locations of the matched patterns to get the “in-between” pixels 846.

Returning now to FIG. 3A, once a z-distance 360 value is obtained using the procedure described above, it can be compared to a pre-determined value or otherwise evaluated to determine whether the optical fiber 320 is vertically aligned to the substrate 305. This comparison may be performed by the image processor 350 and/or a processor of the computing device 352, and the optimized distance can be input by a user or determined using a fitting procedure as described further below. It is to be appreciated that comparisons and/or calculations such as these or other calculations or comparisons described herein may be performed in some instances by the image processor, but may also (or in addition to) may be performed another processor of the computing device 352.

The optical fiber 320 can be moved to a selected or desired z-distance along the z-axis by a drive mechanism 380. As indicated, in some embodiments, the drive mechanism 380 is mechanically attached to the optical fiber 320. In accordance with at least one embodiment, this feature can be used in a calibration process. For example, part of the image processing analysis may also include determining an image compensation calibration curve or factor that accounts for the difference between the “real” and calculated distances between the fiber tip and wafer. As stated previously, the fiber height (z-distance) has the same direction as the z-direction in the image (e.g., see FIG. 5B). Turning now to FIG. 9, an image compensation calibration curve or factor can be determined by moving the optical fiber to (known) selected positions along the z-axis (e.g., by the drive mechanism 380) and comparing these known values to the detected (calculated) z locations for each of the fiber tip and reflection. In the graph of FIG. 9, the x-axis is the “real” or known distance between the fiber tip and the wafer. As indicated in FIG. 9 and according to this particular example, when the distance between the fiber tip and the wafer surface is 0 microns (i.e., the fiber tip is touching the wafer), then the detected number of pixels between the fiber and the wafer is 32 pixels. Looking at FIG. 9 in another way, if the desired distance between the fiber and the wafer surface is 20 microns, then the corresponding number of pixels between the fiber tip and the reflection should be around 48. The maximum z-distance used in this calibration process was 100 microns.

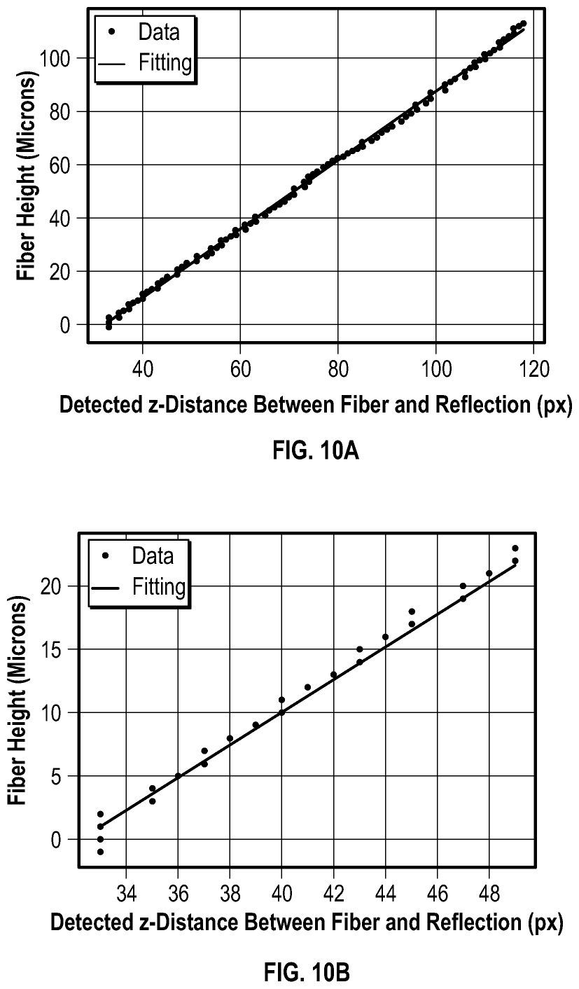

According to a further embodiment, a fitting algorithm can be applied to a comparison between calculated z-distances and “real” or known z-distances. One example of such a fitting technique, which in this example is a linear fitting algorithm, is shown in FIGS. 10A and 10B. A linear fitting algorithm was applied to the data and the linear relationship for the examples shown in the graphs of FIGS. 10A and 10B can be expressed as:

Fiber height (microns)=1.29*distance(px)−41.49 (1)

Obviously, it is to be appreciated that the specific coefficients will change depending on a particular set-up. This relationship can therefore be used to position the fiber at a desired z-distance location above the wafer. It is to be appreciated that in practice calibration processes may be calculated in an initial set-up procedure since touching the wafer with the fiber may cause damage to the fiber and/or the wafer.

In accordance with various aspects a positional error may also be calculated. For example, in one instance linear fitting indicated that fiber movement created a pixel position error of 2.550 microns/pixel. The overall approach can be outlined as follows. The location or distance is calculated from the pixel location of the matched template in the image. This makes the unit of distance in pixels, which is an integer (e.g., 1, 2, 3, etc.). If the real distance is not an integer (e.g., 2.5), then the distance calculated by the matched template will be round up to the next integer (e.g., 2 or 3). This means that the calculated distance (in pixel) has an error around 1 pixel, From the fitting equation (1) above, a 1 pixel error corresponds to a 1.29 micron error. If there is no correction, then the error for the height calculation is ±1.29 microns.

According to another aspect, a fitting algorithm can be applied to reduce the pixel position error. For instance, a linear fitting algorithm may be performed. The fiber can be positioned a series of z-distances from the wafer substrate and then the z-distance between the fiber and the reflection (pixel) can be calculated at each distance. For example, if the target is 20 microns, the fiber can be positioned at around 50 microns, 45 microns, 40 microns, 35 microns, and 30 microns above the wafer surface. A curve similar to that shown in FIGS. 10A and 10B can be drawn (where FIGS. 10A and 10B are used in the calibration set-up, and this process is used more for real alignment), and a corresponding linear fitting can be performed. This can be used to calculate the real fiber height. In some instance this approach can reduce the height error to around 0.1 to 0.5 microns, depending on how many data points are used for the linear fitting. The more data used, the less error is encountered for the height adjustment (with the downside being that more data collection takes more time).

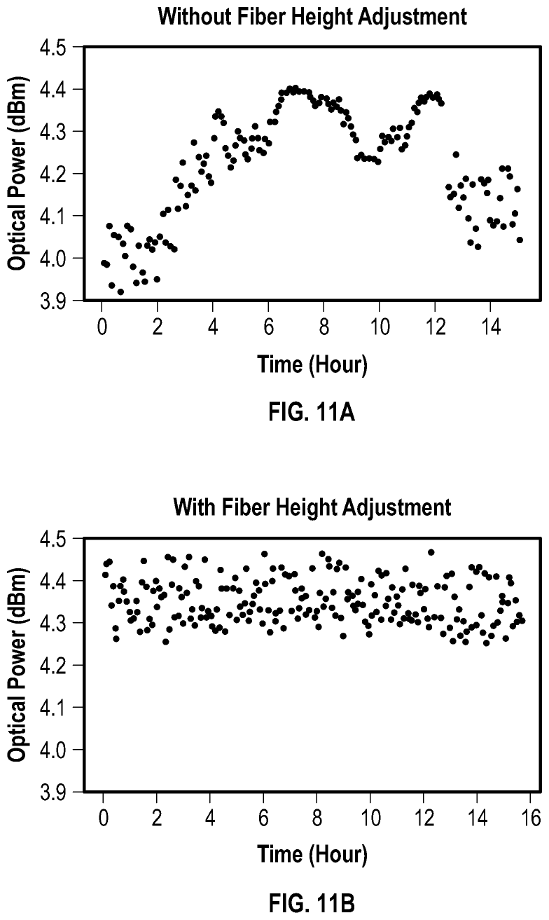

Using the alignment methods described herein, the optical fiber can be vertically aligned such that less than 0.5 decibels (dB) optical insertion loss is introduced between the optical fiber and the substrate, with some results showing this value to be less than 0.2 dB (e.g., 0.15 dB). These values correspond to a vertical alignment positioning precision that is at the micron level, with less than 0.03 dB/μm variability in measured fiber-to-wafer optical insertion loss. For example, experimental data indicated that the average fiber-to-wafer optical insertion loss was 0.025 dB/μm. According to at least one embodiment, the z-distance can be monitored over time and periodic adjustments made to maintain a proper vertical alignment between the fiber and the substrate surface (e.g., PIC chip). FIGS. 11A and 11B include a pair of graphs showing the variability in optical power due to alignment errors over time for a configuration that does not use the disclosed fiber height adjustment (z-distance) technique as described herein (FIG. 11A), as compared to one that does (FIG. 11B). Environmental changes such as temperature, humidity, etc. over time can affect the z-distance alignment of the optical fiber to the PIC chip. The disclosed techniques can be used to periodically measure this z-distance and make adjustments over time to maintain this alignment, as shown in FIG. 11B, where periodic alignment adjustments allowed for the optical power to be maintained within about 0.15 dB. This is a sharp decrease from the optical loss shown in FIG. 11A, which was on the order of about 0.5 dB.

In accordance with another aspect, an x-position of the optical fiber and its reflection can be determined using the technique described herein. In some instances, this information can be used as part of a calibration process. The ability to detect movement of in the x-direction of the optical fiber and its reflection has several practical uses. For instance, aligning the end of the optical fiber to the correct features, e.g., grating coupler, of the waveguide can be challenging on a wafer having many such devices that are in close proximity to one another. It is possible to couple the fiber to a neighboring device instead of the correct device. In addition, when the optical fiber touches the wafer surface (as in the calibration procedure discussed above), it will move slightly toward the direction it is facing, i.e., move in the x-axis direction. Determining the x-position of the optical fiber helps minimize or otherwise prevent error in the alignment process and ensure that no errors occurred during template matching. For instance, error associated with the x-location of the fiber tip and its reflection should be below a (predetermined) threshold value, which in one embodiment is ±1 pixel and in another embodiment is ±2 pixels. Errors above these levels may indicate a problem with the template matching process. The system can do any one of a number of different things (i.e., provide one or more outputs) when an error above the threshold value is detected. For example, an error message may be displayed and/or the measurement process may stop. In some instances, the system moves the fiber and/or wafer to a safe position. An incorrect template match can be caused by any one of a number of different things, including fiber damage or a dirty fiber, and/or view obstruction caused by an external object, etc. Remedies may include a user replacing or cleaning the fiber, and/or removing the obstacle.

The process used to calculate the x-position of the optical fiber and its reflection is similar to that described above in reference to calculating the z-position (e.g., create template images, obtain grayscale image, perform binarization, template match to find x- or z-position of fiber tip and its reflection). This results in an x,z location of the “found” template pattern in the obtained (and processed) camera image.

According to one embodiment, determining the x-position comprises moving the optical fiber to selected positions along the z-axis and determining an x-position for each of the end of the optical fiber and its reflection for at least two selected positions, and then performing a comparison between the determined x-position at the two selected positions for each of the end of the optical fiber and its reflection.

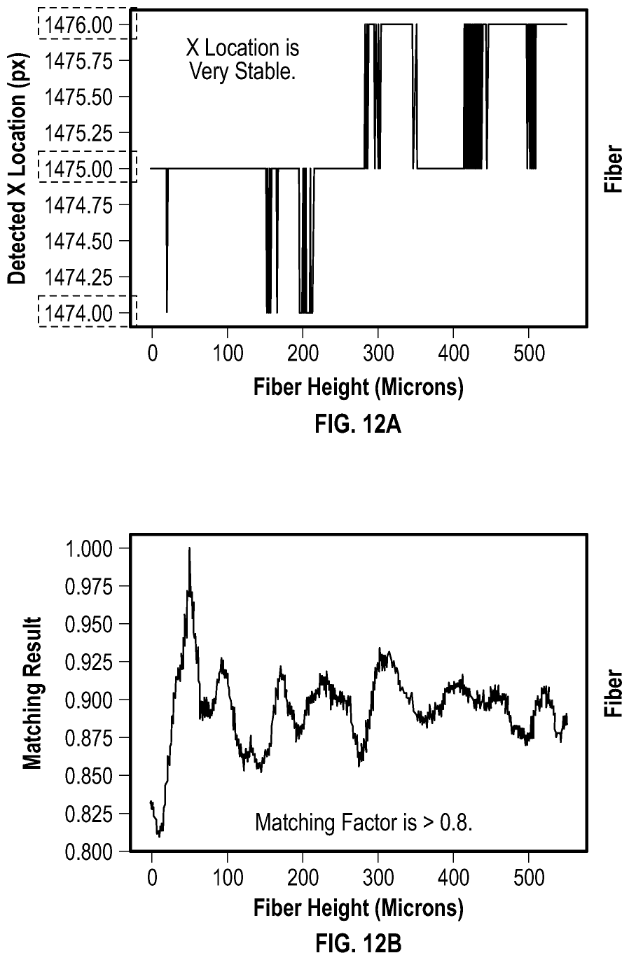

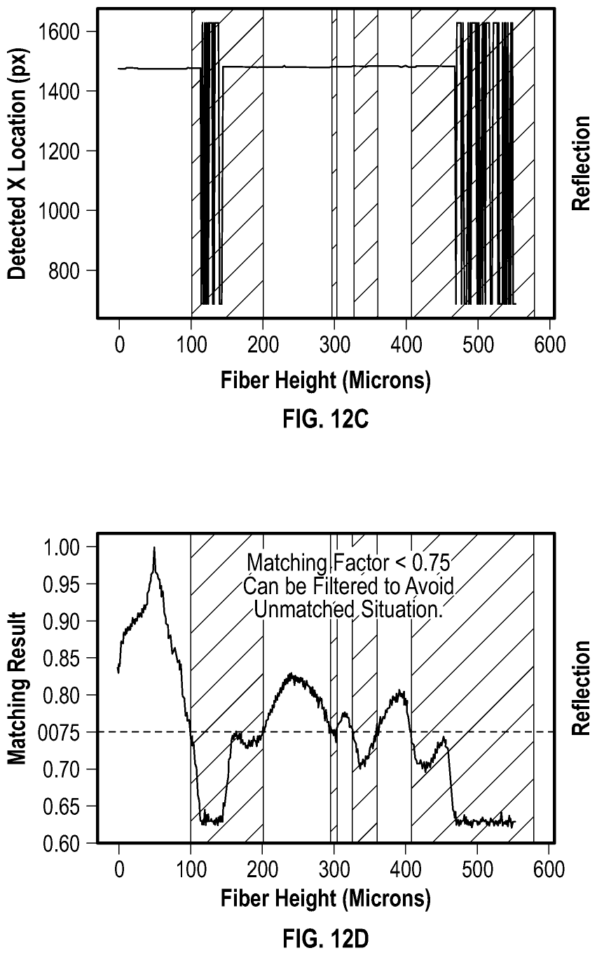

FIGS. 12A-12D show results from an experiment performed to test the stability of the x-position of the end of the optical fiber and its reflection in relation to the substrate surface as the optical fiber was moved through a series of z-distances. FIG. 12A is a graph that plots the z-distance of the fiber from the substrate surface (x-axis) versus the detected x-position of the optical fiber (y-axis). As indicated, the x-position changed by about 2 pixels (i.e., detected pixel position 1474 to 1476). Turning now to the graph shown in FIG. 12B, a correlation or matching factor (y-axis) was also calculated between the estimated position and the real position, which was plotted against known z-distances (x-axis). The results indicated that the matching factor was greater than 0.8 (80%) for z-distances between 0 and 550 microns. Put another way, these results indicated that wherever the fiber tip is located, the detection for the fiber is very good, especially for z-distances between 30 and 100 microns.

The same exercise was repeated for the x-position of the reflection, as shown in corresponding FIGS. 12C and 12D. As indicated in FIG. 12C, the greater than 80% accuracy experienced for the optical fiber detection was decreased for the reflection when the fiber was greater than 100 microns from the substrate surface. This was found to be due to errors in detecting the reflected image. A filtering technique can be applied to improve the matching factor, as shown in FIG. 12D, where a threshold filtering value of 0.75 was selected. Data points that fell below this filtering threshold were filtered out. In this instance, the data indicated that the matching factor (for the reflection) was greater than 80% for z-distances between 0 and 100 microns, and for z-distances between 100 and 550 microns, the matching factor had a value between about 63-83%.

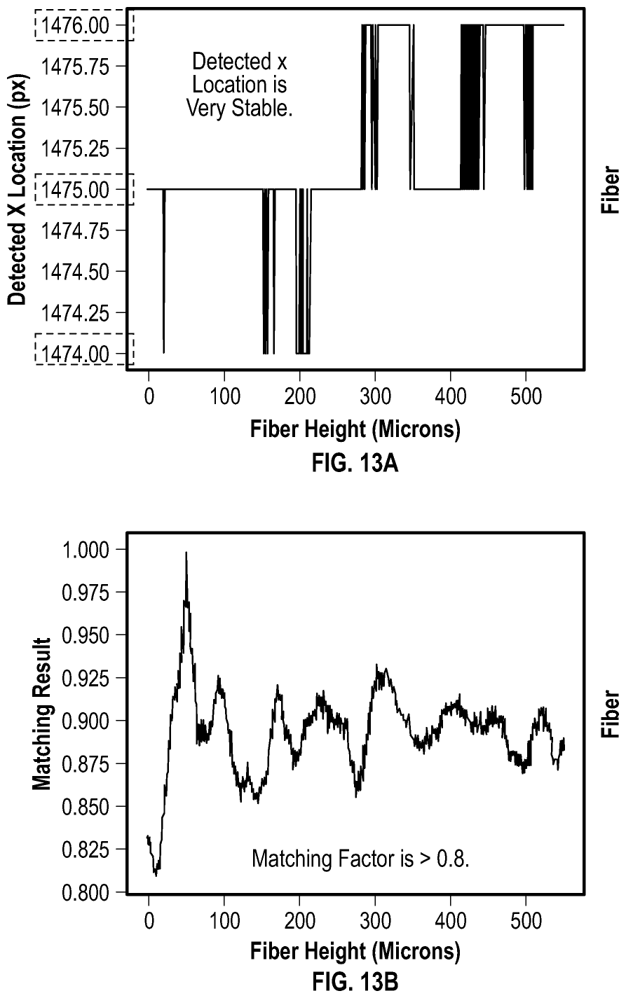

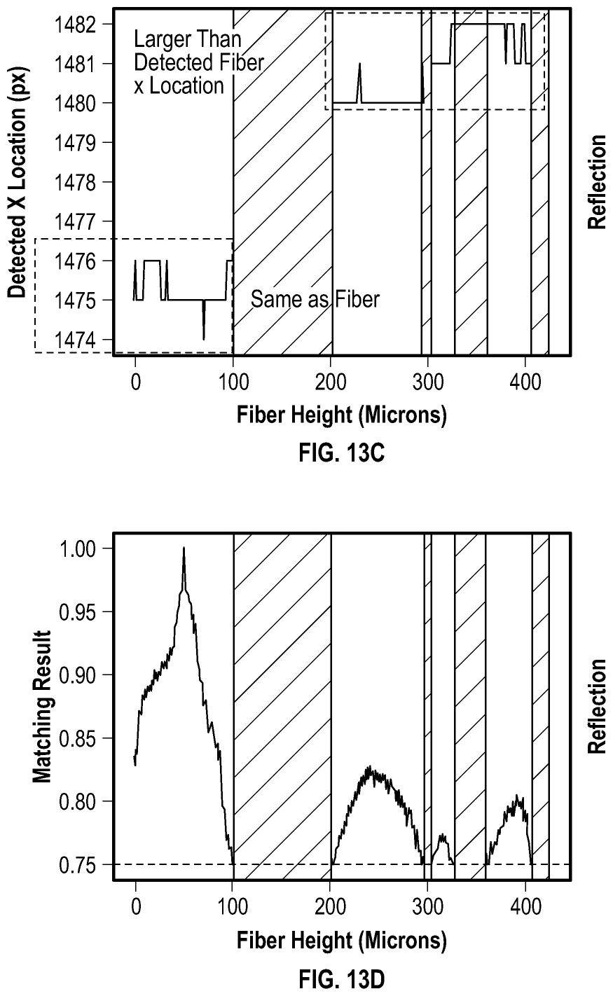

FIGS. 13A and 13B are identical to FIGS. 12A and 12B, but FIGS. 13C and 13D remove the shaded regions from FIGS. 12C and 12D, respectively, where the matching factor of reflection is smaller than 0.75 (the threshold filtering value). The purpose here is to show one non-limiting example where the x location is too large for the matched fiber and matched reflection. The algorithm would require the user to check out the reason for the error. In this instance, the fiber height is too high above the surface and the reflection moves out of the PIC chip. In response, the user should lower the fiber. The approach and response with regard to the matching factor is similar to that discussed above in regard to the x-position. A threshold value for the matching factor can be determined either by the user or the system, and when the calculated value is smaller than this threshold value the system can respond by providing an output, e.g., by outputting an error message, moving the fiber and/or wafer to a safe position, and/or simply stopping the routine.

In FIG. 13C, when the z-distance of the fiber was within 100 microns of the substrate surface, the change in the detected x-position of the reflection was similar to that achieved using the fiber image, i.e., within 2 pixels), however, as was the case in FIG. 12C, this error increased when the fiber was greater than 100 microns from the substrate surface. A filtering technique was also applied in this instance to improve the matching factor using a threshold filtering value of 0.75, with the results shown in FIG. 13D. In addition, as shown in FIG. 13C, when the detected x-location for the reflection image is greater than that of the fiber image, this region can be marked and analyzed separately (e.g., filtered, as shown in FIG. 13D). Generally speaking, the system (e.g., image processor 350 and/or computing device 352) can provide an output when a threshold value is not achieved in some way. For example, if the matching factor is smaller than 0.8 for the fiber, and/or the matching factor is smaller than 0.75 for the reflection, and/or the x-location difference between the fiber and the reflection is larger than 2 pixels (with 0.8, 0.75, and 2 pixels functioning as threshold values), then the system can provide an output, such as moving the fiber and/or wafer to a safe position, prompting a user (e.g., a dialog box or error message) to remedy the situation (which could be cleaning or replacing the fiber or removing an obstacle as previously discussed), and/or simply terminating the procedure.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A method of determining a z-distance between an optical fiber and a substrate, comprising:
obtaining an image that includes an end of the optical fiber and a reflection of the end of the optical fiber from a surface of the substrate; and
processing the image to determine a z-distance along a z-axis between the end of the optical fiber and the substrate.

2. The method of claim 1, wherein obtaining the image includes obtaining a grayscale image that includes a plurality of pixels, and processing the image comprises thresholding the grayscale image to generate a binary image.

3. The method of claim 2, wherein processing the image further comprises:
comparing a first template image corresponding to a representation of the end of the optical fiber to the binary image to detect a first subset of the plurality of pixels in the binary image that match the first template image, the first subset of the plurality of pixels corresponding to a representation of the end of the optical fiber;
comparing a second template image corresponding to a representation of the reflection of the end of the optical fiber from the surface of the substrate to the binary image to detect a second subset of the plurality of pixels in the binary image that match the second template image, the second subset of the plurality of pixels corresponding to a representation of the reflection of the end of the optical fiber from the surface of the substrate; and
determining a number of pixels of the plurality of pixels that exist between the first subset and the second subset, the number of pixels corresponding to the z-distance.

4. The method of claim 3, further comprising obtaining and storing each of the first and second template images.

5. The method of claim 1, further comprising performing a calibration process, the calibration process comprising moving the optical fiber to selected positions along the z-axis.

6. The method of claim 5, further comprising:
determining the z-distance from an image obtained at each selected position; and
applying a fitting algorithm to a comparison between the determined z-distances and known z-distances.

7. The method of claim 5, further comprising:
for each image obtained at each selected position, determining an image z-location for each of the end of the optical fiber and its respective reflection;
comparing the determined image z-locations to known z-distances; and
calculating an image compensation calibration factor based on the comparison.

8. The method of claim 1, further comprising determining an x-position for each of the end of the optical fiber and its reflection.

9. The method of claim 8, wherein determining the x-position comprises moving the optical fiber to selected positions along the z-axis and determining an x-position for each of the end of the optical fiber and its reflection for at least two selected positions, and the method further comprises performing a comparison between the determined x-position at the two selected positions for each of the end of the optical fiber and its reflection.

10. The method of claim 1, further comprising moving the optical fiber to a z-distance at which the optical fiber is vertically aligned to the substrate.

11. The method of claim 10, wherein the optical fiber is vertically aligned such that less than 0.5 decibels (dB) optical insertion loss is introduced between the optical fiber and the substrate.

12. The method of claim 11, wherein the optical fiber is vertically aligned such that less than 0.2 dB optical insertion loss is introduced.

13. The method of claim 10, wherein the optical fiber is vertically aligned with an accuracy within one micron.

14. A system for determining a z-distance between an optical fiber and a substrate, comprising:
a camera configured to obtain an image of an end of the optical fiber and a reflection of the end of the optical fiber from a surface of the substrate; and
an image processor configured to receive and process the image and determine a z-distance along a z-axis between the end of the optical fiber and the substrate.

15. The system of claim 14, wherein the image is a grayscale image that includes a plurality of pixels and the image processor is configured to process the image by thresholding the grayscale image to generate a binary image.

16. The system of claim 15, wherein the image processor is further configured to:
compare a first template image corresponding to a representation of the end of the optical fiber to the binary image to detect a first subset of the plurality of pixels in the binary image that match the first template image, the first subset of the plurality of pixels corresponding to a representation of the end of the optical fiber;
compare a second template image corresponding to a representation of the reflection of the end of the optical fiber from the surface of the substrate to the binary image to detect a second subset of the plurality of pixels in the binary image that match the second template image, the second subset of the plurality of pixels corresponding to a representation of the reflection of the end of the optical fiber from the surface of the substrate; and
determine a number of pixels of the plurality of pixels that exist between the first subset and the second subset, the number of pixels corresponding to the z-distance.

17. The system of claim 14, further comprising a drive mechanism configured to move the optical fiber along the z-axis to selected positions.

18. The system of claim 17, wherein the image processor is configured to determine the z-distance from an image obtained at each selected position, and the system further comprises a computing device configured to apply a fitting algorithm to a comparison between the determined z-distances and known z-distances.

19. The system of claim 17, wherein the image processor is configured to determine an image z-location for each of the end of the optical fiber and its respective reflection for each image obtained at each selected position, and the system further comprises a computing device configured to compare the determined image z-locations to known z-distances, and calculate an image compensation calibration factor based on the comparison.

20. The system of claim 14, wherein the image processor is further configured to determine an x-position for each of the end of the optical fiber and its reflection.

21. The system of claim 20, wherein the image processor is further configured to calculate a matching factor for each of the determined x-positions for the end of the optical fiber and its reflection.

22. The system of claim 21, wherein the image processor is configured to provide one or more outputs when at least one of the calculated matching factors exceeds a threshold value.

23. The system of claim 14, wherein the substrate includes a photonic integrated circuit (PIC), and the optical fiber is vertically aligned to a grating coupler of the PIC.
